(19) United States
(12) Patent Application Publication
(10) Pub. No.: US 2010/0279029 A1
(43) Pub. Date: Nov. 4, 2010

(54) Method for coating nanometer particles

(75) Inventors: Meng-Chu Chen, Taichung City (TW); Shan-Ming Lan, Taoyuan County (TW); Tsun-Neng Yang, Taipei City (TW); Zhen-Yu Li, Chiayi County (TW); Yu-Han Su, Kaohsiung City (TW); Chien-Te Ku, Pingzhen City (TW); Yu-Hsiang Huang, Pingzhen City (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERGY RESEARCH, Taoyuan (TW)

(21) Appl. No.: 11/907,523

(22) Filed: Oct. 12, 2007

(51) Int. Cl. H05H 1/24

(52) U.S. Cl. 427/576

(57) ABSTRACT

There is disclosed a method for coating nanometer metal particles. The step includes three steps. At the first step, a substrate is provided. At the second step, the substrate is coated with a metal layer. At the third step, the metal layer is annealed so that the metal layer is transformed into nanometer metal particles.

### FIELD OF THE INVENTION

The present invention relates to a method for coating nanometer particles and, more particularly, to a method for coating nanometer platinum and gold particles.

### DESCRIPTION OF THE RELATED ARTS

Nanometer technology is a promising field getting a lot of attention. Particularly for the past five years, a lot of money has been invested on nanometer technology around the world, and nanometer technology has become more important than before. However, nanometer technology is facing a serious bottleneck regarding process, equipment and expenses.

Nanometer particles, sometimes called “nano-particles”, are particles with diameters of 1 to 100 nanometers in a transient area between clusters and macroscopic bodies. Nanometer particles belong in a meso-scope system. Nanometer particles provide surface effects, small-size effects and macroscopic quantum tunneling effects. When macroscopic bodies are divided into nanometer particles, the optical, thermodynamic, electrical, magnetic, mechanical and chemical properties thereof are changed considerably. Thus, the nanometer particles can widely be used in the electronic, medical, chemical, military, aeronautic fields. Taking gold (“Au”) for example, if the diameter is smaller than 10 nanometers, the sintering temperature is lower than 200 degrees Celsius, considerably reduced in comparison with its melting point.

Because such nanometer metal particles provide catalyst synthesis, their use in various fields can be expected. Electronic parts require high speed and high density, it is promising to use nanometer particles as the primary gradients of wiring. Moreover, there have been attempts to coat substrates with nanometer metal particles instead of ceramic, glass, polyidmide and ordinary organic substance because of their low sintering temperatures.

To make nanometer particles, there are three catalogs of methods: gas-condensation methods, mechanical synthesis methods and chemical reduction methods. The gas-condensation methods include chemical vapor deposition methods and physical vapor deposition methods.

In a mechanical synthesis method, energetic grinding balls are used to bring large particles of various materials into plastic deformation so that the particles are broken and joined. This process is repeated until the materials become an alloy and nanometer particles are made.

In a chemical reduction method, solution of metal ions in an oxidation state is processed with reductant so that the metal ions are reduced into nanometer zero-valent metal particles.

In the above-discussed methods, the growth of nanometer particles is random, the shapes of the nanometer particles cannot be controlled.

There have been attempts to make nanometer metal particles in liquid chromatograph. For example, in a hydrophobic reaction tank, ammonic ammonium silver complex solution is reduced so that nanometer silver particles are made. The resultant nanometer silver particles however suffer from cohesion.

The present invention is therefore intended to obviate or at least alleviate the problems encountered in prior art.

### SUMMARY OF THE INVENTION

The primary objective of the present invention to provide a method for coating nanometer platinum and gold particles.

To achieve the primary objective of the present invention, the method for coating nanometer metal particles includes three steps. At the first step, a substrate is provided. At the second step, the substrate is coated with a metal layer. At the third step, the metal layer is annealed so that the metal layer is transformed into nanometer metal particles.

Other objectives, advantages and features of the present invention will become apparent from the following description referring to the attached drawings.

### BRIEF DESCRIPTION OF THE DRAWINGS

The present invention will be described via the detailed illustration of the preferred embodiment referring to the drawings.

FIG. 1 is a flowchart of a method for coating nanometer platinum particles according to the preferred embodiment of the present invention.

FIG. 2 is a side view of a substrate onto which a platinum layer will be coated in the method shown in FIG. 1.

FIG. 3 is a side view of a substrate coated with a platinum layer in the method shown in FIG. 1.

FIG. 4 is a simplified side view of a furnace for annealing the substrate and the platinum layer shown in FIG. 3.

FIG. 5 is a side view of the substrate coated with nanometer platinum particles transformed from the platinum layer shown in FIG. 4.

### DETAILED DESCRIPTION OF EMBODIMENT

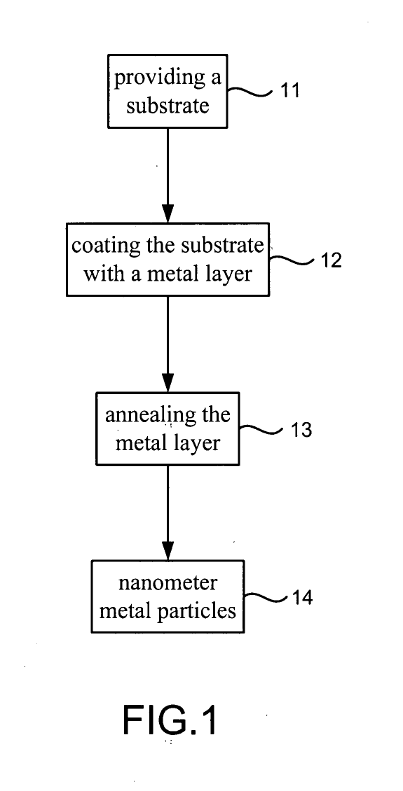

Referring to FIG. 1, there is shown a method for coating nanometer platinum particles according to the preferred embodiment of the present invention.

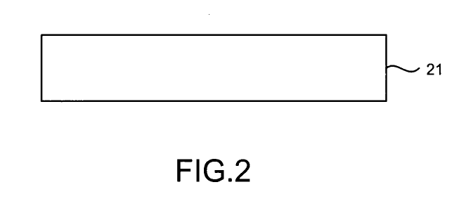

Referring to FIGS. 1 and 2, at 11, there is provided a substrate 21. The substrate 21 may be made of sapphire, quartz, indium-tin oxide (“ITO”), silicon carbide (“SiC”) or gallium arsenide (“GaAs”).

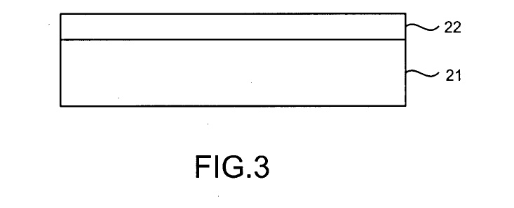

Referring to FIGS. 1 and 3, at 12, the substrate 21 is coated with a platinum layer 22 in a low-temperature plasma deposition method.

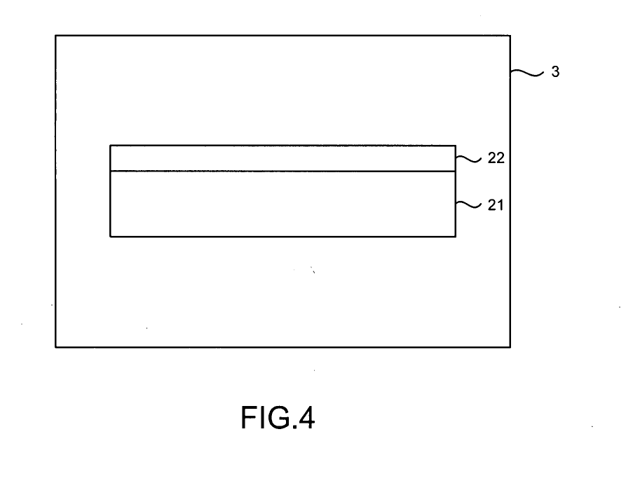

Referring to FIGS. 1 and 4, at 13, the platinum layer 22 and the substrate are disposed in a heating device 3. Inert gas is introduced into the heating device 3. The temperature in the heating device 3 changes to anneal the platinum layer 22. The heating device 3 is preferably an annealing furnace.

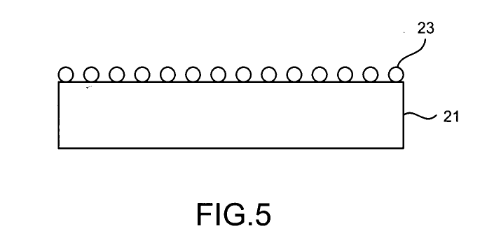

Referring to FIGS. 1 and 5, at 14, the substrate 21 is coated with nanometer platinum particles 23 that are transformed from the platinum layer 22.

In another embodiment, the substrate 21 can be coated with a gold layer instead of the platinum layer 22. Such a gold layer can be disposed and annealed in the heating device 3. Thus, nanometer gold particles can be coated on the substrate 21.

The method according to the present invention exhibits several advantages. Firstly, it is simple. Secondly, the diameters of the nanometer platinum particles are similar. Thirdly, the nanometer platinum particles are distributed evenly. Fourthly, the quality of the nanometer platinum particles is stable so that mass production is possible. The deposition of the nanometer platinum particles is done in a short period of time so that the productivity is high and the cost is low.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for coating nanometer metal particles comprising the steps of:
providing a substrate;
coating the substrate with a metal layer in a low-temperature plasma deposition method; and
providing a heating device for providing a changing temperature for annealing the metal layer so that the metal layer is transformed into nanometer metal particles.

2. The method according to claim 1, wherein the substrate is made of a material selected from a group consisting of sapphire, quartz, indium-tin oxide, silicon carbide and gallium arsenide.

3. The method according to claim 1, wherein the metal layer is a platinum layer.

4. The method according to claim 1, wherein the metal layer is a gold layer.

5. The method according to claim 1, wherein the step of annealing the metal layer comprises the step of introducing inert gas into the heating device.

6. The method according to claim 1, wherein the heating device is an annealing furnace.
